(19) United States
(12) Patent Application Publication
(10) Pub. No.: US 2017/0263103 A1
(43) Pub. Date: Sep. 14, 2017

(54) METHOD AND APPARATUS FOR COLLABORATIVE THREAT ASSESSMENT

(71) Applicant: General Electric Company, Schenectady, NY (US)

(72) Inventor: David Sean Farrell, Lisle, IL (US)

(21) Appl. No.: 15/069,046

(22) Filed: Mar. 14, 2016

(51) Int. Cl. G08B 21/18; G05B 23/02; G07C 3/00

(52) U.S. Cl. CPC G08B 21/185; G07C 3/00; G05B 23/0254

(57) ABSTRACT

Approaches are provided for storing in a memory device a work plan and a case data structure associated with an industrial machine or system. The case data structure includes an impact field with an impact value, and an urgency field with an urgency value. A processor transmits via an output a case report to a plurality of local computing devices at a remote location. The case report is indicative of one or more characteristics of a case. The processor is further configured to receive via an input a plurality of transmissions from the plurality of local computing devices. Each of the transmissions are indicative of an assessed impact and an assessed urgency.

### BACKGROUND OF THE INVENTION

Field of the Invention

The subject matter disclosed herein generally relates to collaborative case threat assessment. More specifically, the subject matter relates to collaborative assessment of case impacts and case urgencies.

Brief Description of the Related Art

In industrial operations, industrial machines and systems are monitored to ensure proper operation and/or detect anomalies which may arise. Remote Monitoring & Diagnostic (M&D) approaches often include personnel at one location communicating with personnel at an operating site located at a separate, geographically remote location. The M&D personnel view information related to industrial machines or systems located at the operating site.

During operation, problems oftentimes occur which may warrant an operator or maintenance engineer's involvement. M&D personnel provide information and recommendations related to the industrial machine or system to personnel at the operating site.

Prior to providing recommendations to operators at the operating site, M&D personnel often consider large amounts of data, such as data associated with the same or similar machine and/or data associated with the same or similar problem. Often absent from this data are assessments from a sufficient number of on-site personnel located at the operating site.

Furthermore, when assessing problems at operating sites, on-site personnel in many instances are unable to quickly and comprehensively jointly consider the urgencies and impacts of multiple problems and threats relating to the machines at the operating site.

The above-mentioned problems have resulted in some user dissatisfaction with previous approaches, inefficient case resolution, and sub-optimal application of remote monitoring and diagnostic approaches.

### BRIEF DESCRIPTION OF THE INVENTION

The approaches described herein provide for methods and apparatuses for collaborative threat assessment. In many of these embodiments, a method includes storing a case data structure in a memory device. The case data structure represents characteristics of a case associated with an abnormality detected in an industrial machine or system. The case data structure includes an impact field with an impact value. The impact value is an indication of a potential harm posed by the abnormality detected in the industrial machine or system. The case data structure also includes an urgency field with an urgency value. The urgency value is an indication of timing associated with the potential harm posed by the abnormality detected in the industrial machine or system.

In some aspects, the case data structure is stored in a memory device at the central computing device at the central location. In other aspects, the case data structure is stored in a memory device at a remote data center.

The method further includes transmitting a case report from a central computing device at a central location to a plurality of local computing devices at a remote location. The case report is indicative of one or more characteristics of the case.

In some approaches, the method includes transmitting a notification indicative of the case report to the plurality of local computing devices. In some aspects, the notification is transmitted to a plurality of subscribed local computing devices that are subscribed to at least one characteristic of the case. The at least one characteristic may be the abnormality detected on the industrial machine or system.

In some approaches, the method further includes entering, at each of the plurality of local computing devices at the remote location, an assessed impact value and an assessed urgency value. In other approaches, the method further includes transmitting, from each of the plurality of local computing devices at the remote location, the assessed impact value and the assessed urgency value.

The method further includes receiving a plurality of transmissions from the plurality of local computing devices. Each of the transmissions are indicative of an assessed impact and an assessed urgency. In some aspects, the plurality of transmissions from the plurality of local computing devices are received at the central computing device at the central location. In other aspects, the plurality of transmissions from the plurality of local computing devices are received at a remote data center. In some approaches, the plurality of transmissions received from the plurality of local computing devices include an assessed confidence value.

In some approaches, the method further includes, in response to receiving the plurality of transmissions, transmitting to one or more local computing devices at the remote location a graphical representation of the plurality of transmissions received from the plurality of local computing devices. In some aspects, the graphical representation comprises an average of the assessed impacts and assessed urgencies.

In many of these embodiments, an apparatus includes an interface with an input and an output. The apparatus further includes a memory configured to store a case data structure. The case data structure represents characteristics of a case associated with an abnormality detected in the industrial machine or system. The case data structure includes an impact field with an impact value. The impact value is an indication of a potential harm posed by the abnormality detected in the industrial machine or system. The case data structure further includes an urgency field with an urgency value. The urgency value is an indication of timing associated with the potential harm posed by the abnormality detected in the industrial machine or system.

The apparatus further includes a processor coupled to the interface and memory. The processor is configured to transmit via the output a case report to a plurality of local computing devices at a remote location. The case report is indicative of one or more characteristics of the case. The processor is further configured to receive via the input a plurality of transmissions from the plurality of local computing devices. Each of the transmissions is indicative of an assessed impact and an assessed urgency.

In some aspect, the processor is further configured to calculate an impact mean and an impact range based on the assessed impacts of the plurality of transmissions. The processor is further configured to calculate an urgency mean and an urgency range based on the assessed urgencies of the plurality of transmissions.

In other approaches, the processor is further configured to determine an intersection between the impact mean and the urgency mean.

In still other approaches, the processor is further configured to provide via the output the intersection between the impact value and the urgency value, the impact range, and the urgency range for display on a graphical display. In this way, a user can concurrently view a relationship between the assessed impacts and the assessed urgencies of the plurality of transmissions.

In another aspect, the graphical display comprises a plurality of relationships representative of assessed impacts and assessed urgencies of a plurality of cases.

### BRIEF DESCRIPTION OF THE DRAWINGS

For a more complete understanding of the disclosure, reference should be made to the following detailed description and accompanying drawings wherein:

FIG. 1 comprises an illustration of an informational flow chart for providing information relating to industrial machines or systems according to various embodiments of the present invention;

FIG. 2 comprises a block diagram illustrating an exemplary case data structure for managing information relating to industrial machines or systems according to various embodiments of the present invention;

FIG. 3 comprises a diagram illustrating an operational flow chart illustrating an approach for case management according to various embodiments of the present invention;

FIG. 4 comprises a diagram illustrating an exemplary approach for graphical display of a case report according to various embodiments of the present invention;

FIG. 5 comprises a block diagram illustrating an exemplary apparatus for managing information relating to industrial machines or systems according to various embodiments of the present invention.

FIG. 6 comprises a diagram illustrating an exemplary approach for graphical display of case information according to various embodiments of the present invention;

FIG. 7 comprises a diagram illustrating an exemplary approach for graphical display of case information according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

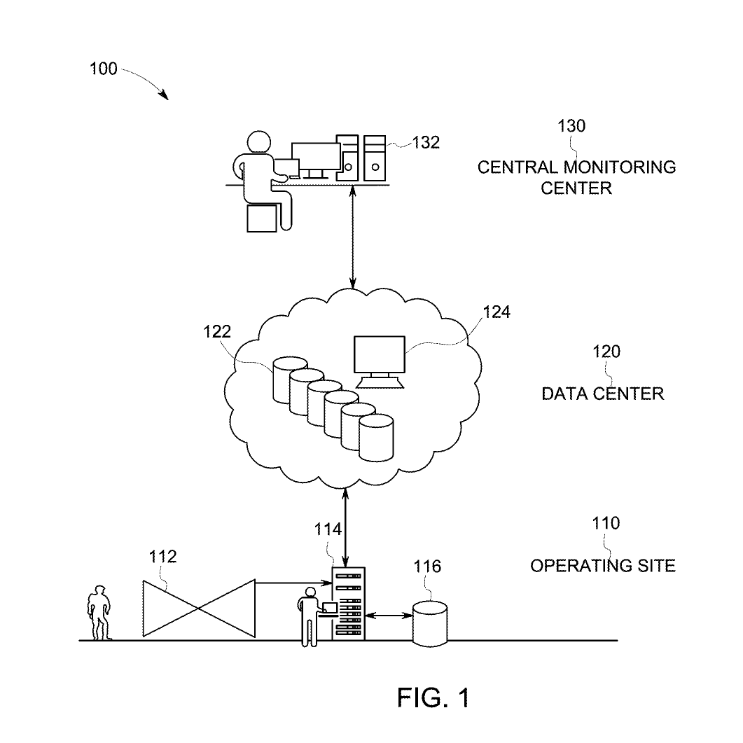

Referring now to FIG. 1, a system 100 for monitoring industrial machines includes an operating site 110, optionally, a data center 120, and a central monitoring center 130. The operating site 110 includes one or more industrial machines, equipment, or systems of industrial machines or equipment 112. Examples of industrial machines 112 monitored in system 100 include aircraft machinery (e.g., turbine engines), marine machinery, mining machinery, oil machinery, gas machinery, health care machinery, telecom machinery, to mention a few examples. Other examples are possible.

Industrial machine 112 is operably connected to a local computing device 114 such that the computing device 114 receives or obtains information from the industrial machine 112. The computing device 114 may be continuously connected to the industrial machine 112, or may be removably connected to the industrial machine 112. In one approach, the computing device 114 is located at the operating site 110. In other approaches, the computing device 114 is instead located remotely from the industrial machine 112.

Information received at the computing device 114 from the industrial machine 112 includes operational characteristics of the industrial machine 112. Operational characteristics may include a measured temperature, a measured vibration, a measured pressured, a calculated efficiency, a structural defect, a lifespan of machine, a machine history, and/or a detected position shift. Other examples are possible.

The computing device 114 may be any type of hardware device such as a personal computer, a tablet, a cellular telephone, and/or a personal digital assistant. Other examples are possible. The computing device 114 may include a processor, an interface (e.g., a computer based program and/or hardware) having an input (which may also include a user input) and an output, a memory, and a display device (e.g., a screen or a graphical user interface which allows for a visualization to be made). In this way, a user of the computing device 114 is able to observe information at the computing device 114 (such as operational characteristics of the industrial machine 112), input information into the computing device 114, send information from the computing device 114 to a remote device (such as at the data center 120 or the central monitoring center 130), and receive information from a remote device. The computer device 114 may be configured to run specific software applications, such as a historian.

The computing device 114 is operably connected to a data storage module 116. The data storage module 116 includes a memory for short- and/or long-term storage of information received from the computing device 114. Examples of information received and stored at the data storage module 116 include historical information relating to the industrial machine 112, or information received at the computing device from a remote device (such as at the data center 120 or the central monitoring center 130).

The optional data center 120 is in communication with the operating site 110 (preferably, with the computing device 114 at the operating site) such that the data center 120 can send and/or receive information pertaining to one or more industrial machines 112 located at the operating site 110. The data center 120 maybe located at the operating site 110, at the central monitoring center 130, or in a location geographically remote from the operating site 110 and the central monitoring center 130. In one approach, the data center 120 is disposed on a cloud-based network.

The data center 120 includes one or more data storage modules 122 having corresponding memories. The data center 120 may also include one or more computing devices 124 that include a processor, an interface having an input (which may include a user input) and an output, a memory, and a display device (e.g., a screen or a graphical user interface which allows for a visualization to be made). Various applications may be performed at the data center 120, including analytic modeling, anomaly detection, and/or calculations of key performance indicators.

The central monitoring center 130 includes a computing device 132 that is in communication with the data center 120 such that the central monitoring center 130 can send and/or receive information pertaining to one or more industrial machines 112 located at the operating site 110. Alternatively, the central monitoring center 130 is in communication with the operating site 110 (preferably, with the computing device 114 at the operating site) such that the central monitoring center 130 can send and/or receive information pertaining to one or more industrial machines 112 located at the operating site 110.

In one example of the operation of the system 100 of FIG. 1, when an anomaly, abnormality, or incident is detected in an industrial machine or system (such as machine 112 of FIG. 1), a case data structure (or combination of case data structures) associated with the case is created and stored in a memory device of an apparatus that may be, for example, at the data center 120 or at the central monitoring center 130. As used herein, a “case” is associated with an anomaly, an abnormality, or an incident detected in an industrial machine or system, and a “case data structure” includes a data structure that represents a compilation of characteristics of the case. In one approach, the case data structure is generated by personnel at the central monitoring center 130. In another approach, the case data structure is generated by operating site personnel at a local computing device (e.g., local computing device 114 at the operating site 110). In either approach, a user may link evidence, expert interpretation associated with the evidence, metadata describing the particular nature of the industrial machine at issue, and/or other relevant information such that a visual aid is created.

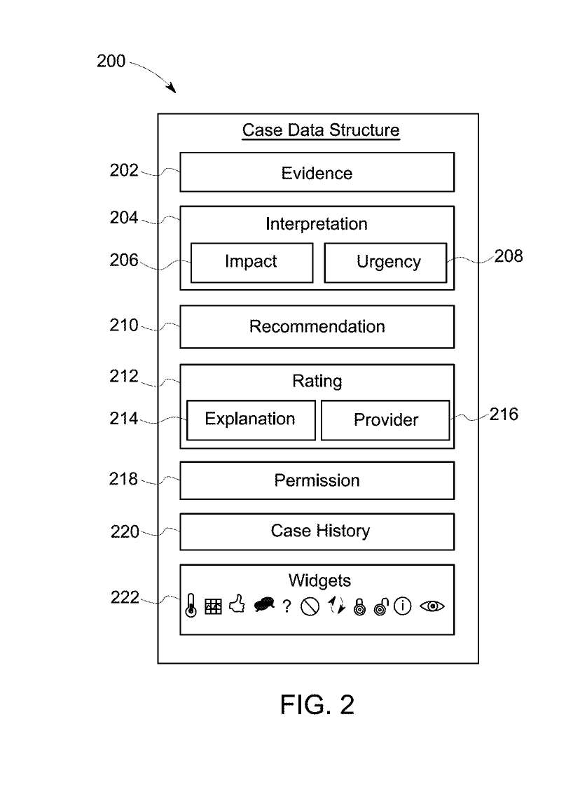

An example case data structure 200 is shown in FIG. 2. The case data structure represents 200 characteristics of a case associated with an abnormality detected in an industrial machine or system. The case data structure 200 may include an evidence field 202 with evidence. The evidence includes information associated with the anomaly and/or the industrial machine 112. For example, the evidence associated with the industrial machine or system may include: a measured temperature, a measured vibration, a measured pressured, a calculated efficiency, a structural defect, a lifespan of machine, a machine history, and/or a detected position shift. The evidence may be in the form of advisories, alarms, charts, or reports.

The case data structure 200 also includes an interpretation field 204 with one or more interpretations. The interpretation includes a user determined condition based at least in part on the evidence. For example, the interpretation may comprise a case diagnosis or a case prognosis.

The interpretation field 204 further includes an impact field 206 for storing an impact value. The impact value provides an indication of a potential harm posed by the abnormality detected in the industrial machine or system 112. For example, an assessed impact associated with a problematic machine on an oil platform may be a given number of barrels of lost production. If the number of barrels of lost production is relatively minor, the impact field is assigned a low impact value. Conversely, if the number of barrels of lost production is relatively major, the impact field is assigned a high impact value.

The interpretation field 204 further includes an urgency field 208 for storing an urgency value. The urgency value is an indication of timing associated with the potential harm posed by the abnormality detected in the industrial machine or system. In some approaches, the urgency value is an indication of how soon an analyst determines the abnormality should be addressed. In other approaches, the urgency value is an indication of how soon the harm posed by an abnormality is expected to occur. For example, if the expected lost production for an oil platform is anticipated to occur in the relatively near future, the urgency field is assigned a first urgency value indicative of this timing. If the expected lost production is anticipated to occur in the relatively distant future, the urgency field is assigned a second urgency value indicative of this timing.

The case data structure 200 may also include a recommendation field 210, a rating field 212 (which may further include a rating explanation field 214 and/or a rating provider field 216), a permission field 218, a case history field 220, and/or one or more widgets 222.

In some aspects, assessment of a case impact or case urgency may be improved through collaboration of on-site personnel located at the operating site (e.g., operating site 110). Such collaboration may, in turn, provide a more accurate understanding of the case impact or case urgency, thereby allowing a more optimal decision to be made by personnel at the operating site 110 in resolving the case.

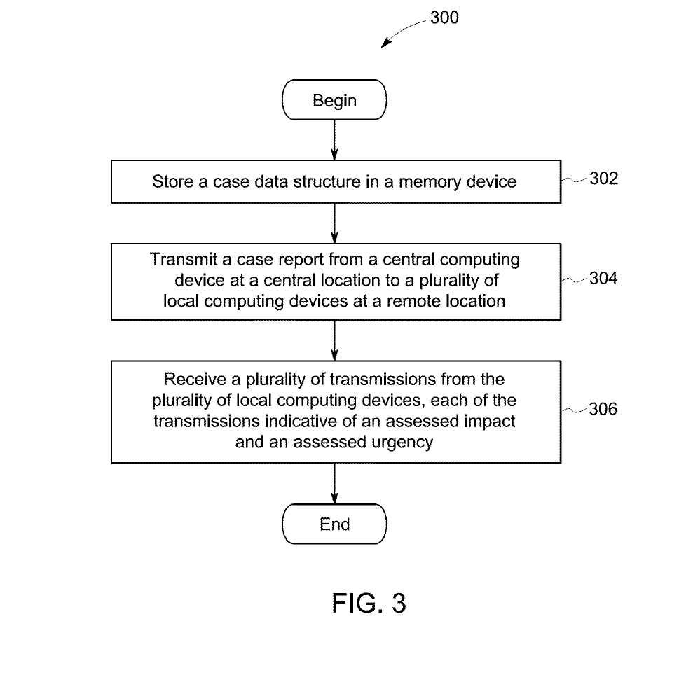

In this regard, with reference to FIG. 3, a method 300 includes storing 302 a case data structure in a memory device. In some aspects, the case data structure is stored in a memory device at a central computing device at a central location (e.g., central monitoring center 130 of FIG. 1). In other aspects, the case data structure is stored in a memory device at a remote data center (e.g., data center 120 of FIG. 1). The case report, described in greater detail elsewhere herein, is indicative of one or more characteristics of the case.

The method 300 further includes transmitting 304 a case report to a plurality of local computing devices at a remote location. The case report in some approaches is transmitted from a central computing device at a central location. In other approaches, the case report is transmitted from a remote data center.

The plurality of local computing devices may include, for example, a desktop computer, a laptop computer, a portable tablet, or a mobile phone located at the remote location. Other examples are possible. In this way, multiple on-site personnel at the operating site can receive and review the case report in a convenient manner.

As discussed in greater detail elsewhere herein, the case report allows multiple users at the local computing devices at the remote location to enter values indicative of assessed case impacts and assessed case urgencies. The assessed impact and urgency values may then be transmitted, for example, to the central computing device and/or a remote data center.

The method 300 further includes receiving 306 a plurality of transmissions from the plurality of local computing devices, wherein each of the transmissions are indicative of an assessed impact and an assessed urgency.

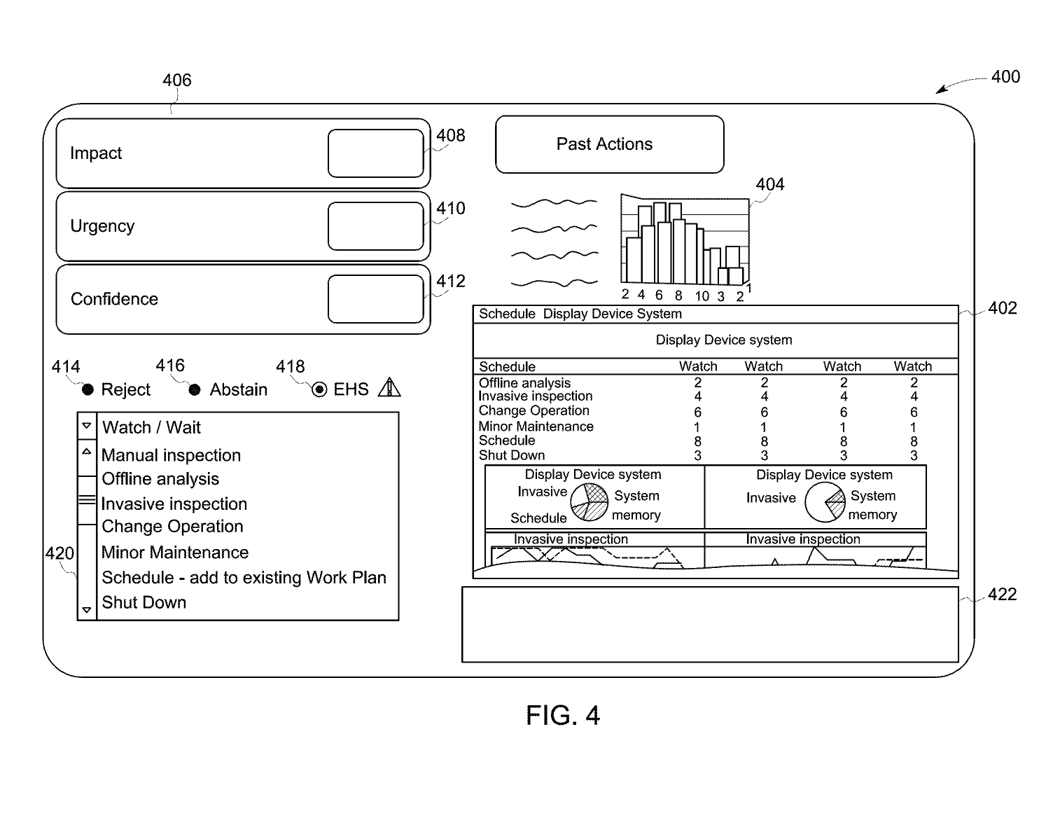

One example of a case report 400 is shown in FIG. 4. The case report 400 includes information 402 associated with an anomaly, abnormality, or incident detected in an industrial machine or system. The case report 400 may also include information 404 pertaining to past actions associated with the industrial machine or system, or information pertaining to the anomaly, abnormality, or incident detected in the industrial machine or system. Using this information, a user at the local computing device is able to efficiently assess the case to determine a case urgency and impact of the case.

The case report 400 includes an assessment parameter entry panel 406. The assessment parameter entry panel 406 includes an impact parameter entry field 408 in which a user at the local computing device enters value indicative of the user's assessment of the case impact.

The assessment parameter entry panel 406 also includes an urgency parameter entry field 410 in which a user at the local computing device enters a value indicative of the user's assessment of the case urgency. In some approaches, the assessment parameter entry panel 406 includes a confidence parameter entry field 412 in which a user at the local computing device enters a confidence value of one or both of the user's assessment of the case impact and the user's assessment of the case urgency.

User assessments may be in any suitable form. For example, a user assessment may be a binary rating selected from a group of two values. Binary ratings may be numerical (e.g., “0”/“1”; “1”/“2”), descriptive (e.g., “Yes”/“No”; “High/Low”), or graphical (e.g., a thumbs up/down icon; star/no star; a smiling/frowning face). In other approaches, the user assessment is selected from a group of three or more values. The values may be graduated numerical ranges (e.g., “1” through “5”), descriptive (e.g., “Yes”/“Maybe”/“No”; “High/Medium/Low”), or graphical (e.g., one/two/three stars; a smiling/straight/frowning face). In other approaches, the user might enter a continuous value, such as the dollar impact of expected loss if the threat progresses.

The case report 400 may also include various input options for a user to select, such as a “Reject” selection 414, an “Abstain” selection 416, or an Environment, Health, and Safety (EHS) selection 418 to indicate an EHS risk. The case report 400 may also include a “next step” selection 420 that may be, for example, a drop-down menu. In some approaches, the case report 400 also includes a free-form text entry pane 422 to allow a user at the central computing device or a user at the local computing device to convey a message within the case report 400.

In some aspects, prior to transmitting the case report, a notification is transmitted (e.g., by the central computing device or another device) to the plurality of local computing devices. The notification may be, for example, in the form of an email or text message and provides an indication that a case report is ready for review.

In some approaches, the case report is transmitted to a plurality of selected local computing devices. The selected local computing devices may be selectively chosen, for example, by personnel at the central monitoring center. In one aspect, the selected local computing devices are selectively chosen based on the location of the selected local computing devices. For example, a case report may be transmitted only to local devices known or believed to be physically located in a control room of a given offshore oil platform. In another aspect, the selected local computing devices are selectively chosen based on on-site personnel associated with the selected local computing devices. The on-site personnel may associate with a local computing device by logging into a software program on or from the local computing device. For example, a case report may be transmitted only to local devices known or believed to be associated with maintenance technicians on a given offshore oil platform.

In some approaches, the case report is transmitted to a plurality of subscribed local computing devices and/or subscribed users. Case report subscriptions may be based on a case data structure characteristic, such as a given industrial machine or system, a given abnormality detected, a threshold case impact value, or a threshold case urgency value. In one example, a crane operator at an offshore oil platform may subscribe to receive case reports that relate to cranes on that platform. In another example, a maintenance technician may subscribe to receive case reports that relate to abnormal vibrations detected on that platform. In yet another example, a team leader may subscribe to receive case reports that have a threshold impact value or a threshold urgency value.

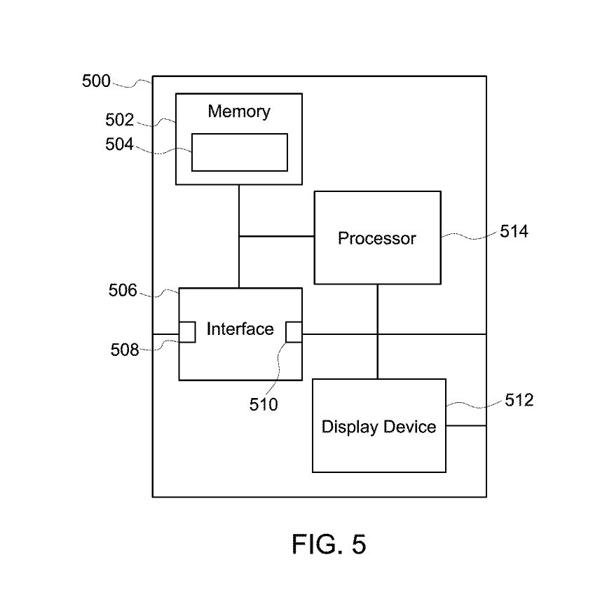

With reference now to FIG. 5, an apparatus 500 (such as computing device 132 of FIG. 1) includes a memory device 502. The memory device 502 stores a case data structure 504. As discussed with respect to the case data structure 200 of FIG. 2, the case data structure 504 represents characteristics of a case associated with an abnormality detected in the industrial machine or system. The case data structure 504 includes an impact field with an impact value. The impact value is an indication of a potential harm posed by the abnormality detected in the industrial machine or system. The case data structure 504 also includes an urgency field with an urgency value. The urgency value is an indication of timing associated with the potential harm posed by the abnormality detected in the industrial machine or system.

The apparatus 500 further includes an interface 506 including an input 508 (which preferably includes a user input) and an output 510. The apparatus 500 may also include a display device 512. The apparatus 500 includes a processor 514 coupled to the memory device 502, and the interface 508, and optionally, the display device 512. The processor 514 is configured to transmit via the output 510 a case report to a plurality of local computing devices at a remote location. The case report is indicative of one or more characteristics of the case.

The processor 514 is further configured to receive via the input 508 a plurality of transmissions from the plurality of local computing devices. The received transmissions are indicative of threat impacts and threat urgencies, as assessed by personnel at the plurality of local computing devices.

In some approaches, the processor 514 is further configured to perform calculations based on the assessed impacts and assessed urgencies received from the on-site personnel. The calculations may provide a statistical mean, median, mode, and range of the assessed impacts and assessed urgencies.

In one aspect, the processor 514 is configured to calculate an impact mean and an impact range based on the assessed impact values of the plurality of transmissions. The impact mean is calculated by adding the assessed impact values and dividing by the number of assessed impact values. The impact range is the difference between the largest and smallest assessed impact values.

The processor 514 is further configured to calculate an urgency mean and an urgency range based on the assessed urgency values of the plurality of transmissions. The urgency mean is calculated by adding the assessed urgency values and dividing by the number of assessed urgency values. The urgency range is the difference between the largest and smallest assessed urgency values.

In some aspects, the processor 514 is configured to weigh various assessed impact values and assessed urgency values differently in computing impact means and impact ranges, and urgency means and urgency ranges. For example, the processor 514 may be configured to weigh various assessed impact values and assessed urgency values differently based on the role, the expertise, the assessed confidence value, or previous assessments of the respective on-site personnel.

The processor 514 is further configured to determine an intersection between the impact mean and the urgency mean for a given case. In some approaches, the intersection is a location on a Cartesian graph, in which an X axis is indicative of an assessed urgency, and a Y axis indicative of an assessed impact, as discussed in greater detail herein.

In some approaches, the processor 514 is further configured to provide via the output 510 the intersection between the mean impact value and the mean urgency value, the impact range, and the urgency range for display on a graphical display. This allows a user to concurrently view a relationship between the assessed impacts and the assessed urgencies of the plurality of transmissions, and across a number of threat cases such as at an entire operating site.

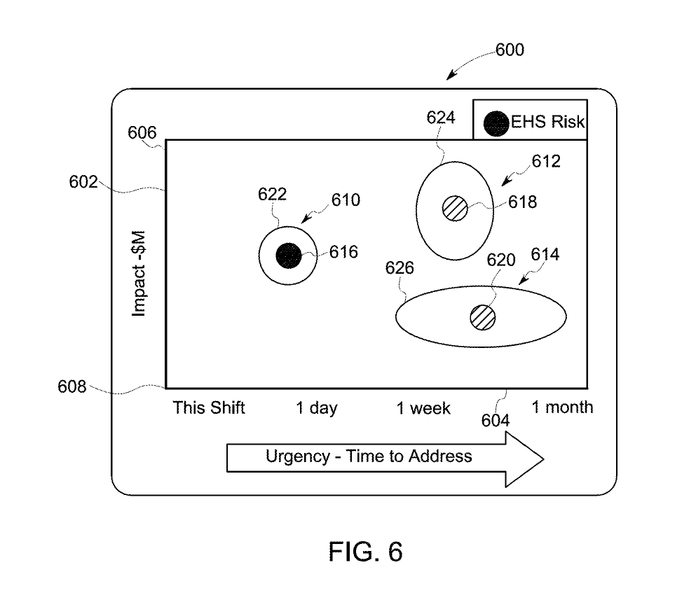

An example graphical display is shown in FIG. 6. Graphical display 600 includes a Cartesian graph 602 with an X axis 604 indicative of an urgency value, and a Y axis 606 indicative of an impact value. Higher urgency values (indicative of sooner realization of the potential harm posed by the abnormality detected in the industrial machine or system) are plotted on the X axis 604 closer to the origin 608 than lower urgency values. Higher impact values (indicative of greater potential harm posed by the abnormality detected in the industrial machine or system) are plotted on the Y axis 606 further from the origin 608 than lower impact values.

The example graphical display 600 of FIG. 6 portrays a first case 610, a second case 612, and a third case 614. The three cases may be associated with the same industrial machine, a plurality of industrial machines used in the same industrial system (e.g., three distinct machines used with respect to an oil platform), three distinct and unrelated machines, or any combination thereof.

In each case, a processor (e.g., processor 514) determines on graph 602 an intersection location between the impact mean and the urgency mean. The intersections 616, 618, 620 of the impact values and urgency values of the first case 610, second case 612, and third case 614, respectively, are represented by visual indicators; in this example, circular dots.

As readily apparent in the graphical display 600 of FIG. 6, the first case 610 includes a greater urgency mean than the other cases. The second case 612 includes a greater impact mean than the other cases.

The impact ranges and urgency ranges 622, 624, 626 of the first case 610, second case 612, and third case 614, respectively, are also represented by visual indicators; in this example, circles or ovals. In the first case 610, both the assessed impact values and assessed urgency values fell within a relatively narrow range. Thus, the ranges 622 are reflected by a relatively small circle. In the second case 612, the assessed urgency values fell within a relatively narrow range, while the assessed impact values varied to a greater extent than in the first case 610. Thus, the ranges 624 are reflected by a vertically-oriented oval. In the third case 614, the assessed impact values fell within a relatively narrow range, while the assessed urgency values varied to a greater extent than in the first case 610. Thus, the ranges 626 are reflected by a horizontally-oriented oval.

With the assessed impact values, the assessed urgency values, and the assessed value ranges shown concurrently on graph 602, the graphical display 600 allows a user to quickly observe the values and their relationships. For example, because the assessed urgency value of the first case 610 (indicated by intersection 616) is closer in proximity along the X axis 604 to the origin 608 than the other cases, a user is quickly informed that the first case 610 has a greater urgency than the other cases. Furthermore, because the assessed impact value of the second case 612 (indicated by intersection 618) is further in proximity along the Y axis 604 from the origin 608 than the other cases, a user is quickly informed that the second case 612 has a greater potential impact than the other cases.

To better assist a user in quickly appreciating the significance of the cases, additional visual representations such as color coding may be used. For example, when it is determined that a case (such as the first case 610) presents an EHS (environment-health-safety) risk, one or both of the intersection 616 and ranges 622 may be displayed as red.

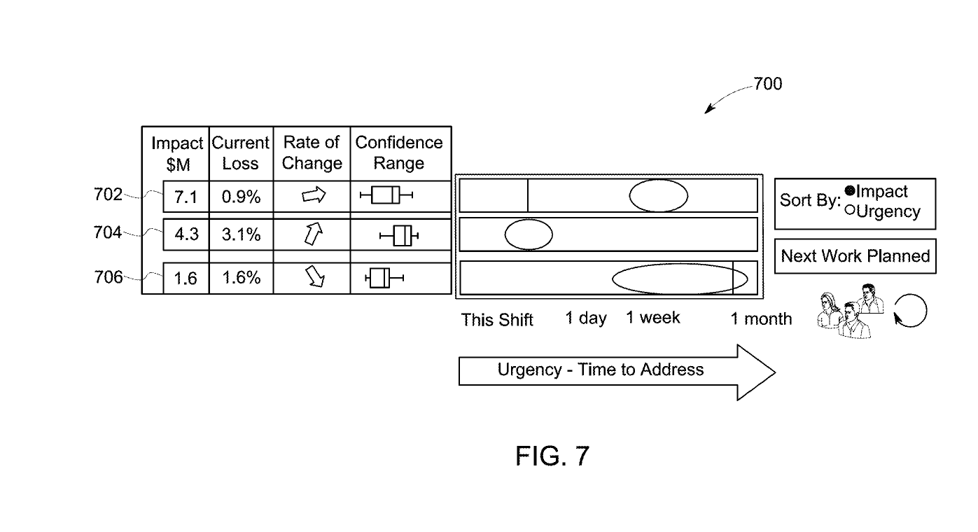

Another graphical display 700 for use in the approaches described herein is shown in FIG. 7. In this graphical display 700, impact values for a first case 702, a second case 704, and a third case 706 are displayed. The impact values are indicative of the magnitude of potential harm posed by an abnormality detected in the industrial machine or system. The vertical dimension displays a ranking of the threats based on a calculated impact mean, with highest threat on top. Urgency values, shown as circles or ovals in graphical display 700, are also displayed. These may have the ‘range’ width meaning calculated and ascribed as in the graphical display of FIG. 6. The placement of the urgency values on graphical display 700 is indicative of how soon the potential harm is expected to occur. The graphical display 700 can be sorted by impact values or urgency values. In viewing the graphical display 700 of FIG. 7, a user can readily decide to allocate maintenance resources to the second case 704, which has been assessed to be the most urgent case. Additional information, such as current loss, rate of change, and confidence ranges may also be displayed. In particular, this embodiment has added a ‘next planned work’ indication to the plot for each case/row (indicated by a vertical line, and preferably shown as a light blue vertical line). This helps make clear the match or mismatch in applying maintenance resources in the actual threat locations. For example, the team should ensure the work approximately one day; hence, in the area of the top ranked threat does in fact address that threat. With respect to the second ranked threat, no work is planned. Thus, to address the threat, work needs to be reallocated away from other areas. The third ranked threat has a reasonable sufficiency of alignment of the work plan with the judged threat.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method comprising:
storing a case data structure in a memory device, the case data structure representing characteristics of a case associated with an abnormality detected in an industrial machine or system, the case data structure comprising:
an impact field with an impact value, the impact value being an indication of a potential harm posed by the abnormality detected in the industrial machine or system;
an urgency field with an urgency value, the urgency value being an indication of timing associated with the potential harm posed by the abnormality detected in the industrial machine or system;
transmitting a case report from a central computing device at a central location to a plurality of local computing devices at a remote location, the case report indicative of one or more characteristics of the case within the case data structure; and
receiving a plurality of transmissions from the plurality of local computing devices, each of the transmissions indicative of an assessed impact and an assessed urgency.

2. The method of claim 1, wherein the case data structure is stored in a memory device at the central computing device at the central location.

3. The method of claim 1, wherein the case data structure is stored in a memory device at a remote data center.

4. The method of claim 1, wherein the plurality of transmissions from the plurality of local computing devices are received at the central computing device at the central location.

5. The method of claim 1, wherein the plurality of transmissions from the plurality of local computing devices are received at a remote data center.

6. The method of claim 1, further comprising:
at the central computing device, transmitting a notification indicative of the case report to the plurality of local computing devices.

7. The method of claim 6, wherein the notification is transmitted to a plurality of subscribed local computing devices, the local computing devices subscribed to at least one characteristic of the case.

8. The method of claim 7, wherein the at least one characteristic selected from the group consisting of: the industrial machine or system, the abnormality detected, an impact value, or an urgency value.

9. The method of claim 1, wherein the plurality of transmissions received from the plurality of local computing devices comprise an assessed confidence value.

10. The method of claim 1, further comprising:
entering, at each of the plurality of local computing devices at the remote location, an assessed impact value and an assessed urgency value.

11. The method of claim 10, further comprising:
transmitting, from each of the plurality of local computing devices at the remote location, the assessed impact value and the assessed urgency value.

12. The method of claim 1, further comprising:
in response to receiving the plurality of transmissions, transmitting to one or more local computing devices at the remote location a graphical representation of the plurality of transmissions received from the plurality of local computing devices.

13. The method of claim 12, wherein the graphical representation comprises an average of the assessed impacts and assessed urgencies.

14. An apparatus comprising:
an interface with an input and an output;
a memory configured to store a case data structure, the case data structure representing characteristics of a case associated with an abnormality detected in the industrial machine or system, the case data structure comprising:
an impact field with an impact value, the impact value being an indication of a potential harm posed by the abnormality detected in the industrial machine or system;
an urgency field with an urgency value, the urgency value being an indication of timing associated with the potential harm posed by the abnormality detected in the industrial machine or system;
a processor coupled to the interface and memory, the processor configured to transmit via the output a case report to a plurality of local computing devices at a remote location, the case report indicative of one or more characteristics of the case within the case data structure, the processor further configured to receive via the input a plurality of transmissions from the plurality of local computing devices, each of the transmissions indicative of an assessed impact and an assessed urgency.

15. The apparatus of claim 14, wherein the processor is further configured to calculate:
an impact mean and an impact range based on the assessed impacts of the plurality of transmissions; and
an urgency mean and an urgency range based on the assessed urgencies of the plurality of transmissions.

16. The apparatus of claim 15, wherein the processor is further configured to determine an intersection between the impact mean and the urgency mean.

17. The apparatus of claim 16, wherein the processor is further configured to provide via the output the intersection between the impact value and the urgency value, the impact range, and the urgency range for display on a graphical display so that a user can concurrently view a relationship between the assessed impacts and the assessed urgencies of the plurality of transmissions.

18. The apparatus of claim 17, wherein the graphical display comprises a plurality of relationships representative of assessed impacts and assessed urgencies of a plurality of cases.
